(19) United States
(12) Patent Application Publication
(10) Pub. No.: US 2008/0063777 A1
(43) Pub. Date: Mar. 13, 2008

(54) EGG PRODUCTS AND METHODS OF FORMING EGG PRODUCTS

(75) Inventors: Donald Roberts, St. Michael, MN (US); Jamie Stout, Otsego, MN (US); Aaron Martin, Albertville, MN (US); Robert Prochnow, Dellwood, MN (US); Rae Guillermo, Aurora, IL (US)

Correspondence Address: CARGILL INCORPORATED, LAW DEPT/MS 24, 15407 MCGINTY ROAD W, WAYZATA, MN, 55391, US

(73) Assignee: Cargill, Incorporated, Wayzata, MN (US)

(21) Appl. No.: 11/766,839

(22) Filed: Jun. 22, 2007

Related U.S. Application Data
(60) Provisional application No. 60/843,180, filed on Sep. 8, 2006.

(51) Int. Cl. A23L 1/32; A21D 13/00; A23P 1/10; B23P 17/00; A21D 13/08

(52) U.S. Cl. 426/558; 29/592; 426/515; 426/614

(57) ABSTRACT

Shaped egg fillings for use in pre-cooked food products such as breakfast sandwiches and breakfast burritos are described. The shaped egg filling are cooked in an egg pan having a plurality of recesses that are formed by a machine milling operation.

### CROSS-REFERENCE TO RELATED APPLICATIONS

This application claims the benefit under 35 U.S.C. § 119(e) of U.S. provisional application No. 60/843,180 entitled “Egg Products and Methods of Making Egg Products,” which has a filing date of Sep. 8, 2006. This application is incorporated by reference in its entirety.

### TECHNICAL FIELD

The present invention relates to egg products and methods of making egg products. More particularly, the present invention relates to pre-cooked egg products used in consumable food products that are typically refrigerated or frozen for subsequent heating.

### BACKGROUND

Pre-cooked breakfast products such as breakfast sandwiches, breakfast burritos and the like typically include a pre-cooked egg filling or insert. These egg fillings are typically formed from a mixture of liquid eggs, additives such as various preservatives, flavorings, starches, gums, etc., and food materials such as meats, cheeses and/or vegetables. The egg mixture is then deposited in a plurality of circular recesses formed in an egg pan and cooked in an oven. The resulting egg patties have a thin, circular shape like a patty, and are typically frozen for subsequent use.

FIGS. 1 and 2 show respective top and bottom views of conventional egg pans 2 used to cook such egg fillings. The illustrated egg pans are typically formed by stamping the circular recesses 4 into a stainless steel sheet or similar stainless steel substrate. The recesses have a depth of about ½ in, and the side wall 6 that intersects the bottom 8 of the recesses exhibits little curvature.

Certain breakfast and other food products require egg fillings to have shapes with a greater thickness or more pronounced curvature than the egg patties described above. Breakfast wraps and burritos, for example, may utilize an egg filling having a generally rectangular or oblong “loaf” shape (i.e., substantially longer than it is wide) with a thickness greater than ½ in. Unfortunately, conventional stamping processes used to form shallow recesses in metal (e.g., stainless steel) egg pans such as the egg pans 2 shown in FIGS. 1 and 2, are not well suited to forming recesses that have significant depths (e.g., greater than about ½ in. for 22 gauge or thinner stainless steel), or which include a curved bottom or other surface having a small radius of curvature (e.g., less than about 3-4× the thickness of the material). In particular, conventional stamping processed tend to form cracks in the recess walls when the metal is stretched beyond its capability. Even if cracking is avoided, microscopic fissures may form that make the recesses more difficult to coat with a suitable non-stick layer and/or to sanitize after use. Similarly, such fissures may also shorten the usable life of the pan.

Accordingly, to form such shaped egg fillings, conventional patty-shaped egg fillings are generally trimmed, shaped, or otherwise modified after cooking or partial cooking to the desired shape. There are several drawbacks to this approach. For example, modifying the egg patties is relatively labor intensive. Similarly, additional handling of the egg products creates an increased risk of product contamination. Further, it may be difficult to form egg products having a consistent shape and smooth surfaces, both because of difficulties in modifying the shape of egg patties, and because food particles in the modified egg patties may create misshapen portions and/or non-smooth surfaces that tend to tear or pierce tortillas or similar wrapping material.

U.S. published application 2003/0224098 to Matthews describes an alternate method for forming shaped egg products in which cooked scrambled eggs are prepared, the scrambled eggs are combined with non-egg ingredients in a shaped cooking mold, and the resulting mixture is then placed in a the mold prior to freezing to form a shaped egg product that may be heated prior to consumption. This method has potential drawbacks including that it may be more difficult to evenly distribute non-egg materials after scrambling, that the scrambled egg curds may not bind to one another suitably after molding, and that the additional processing steps after pre-cooking the eggs may create an increased contamination risk.

### SUMMARY

One embodiment of the present invention provides a method for preparing a shaped egg product. The method includes the steps of providing a liquid egg material, dispensing the liquid egg material into a plurality of recesses in an egg pan formed by a machine milling operation, and cooking the dispensed egg material. By machine milling the recesses into the pan, shaped egg products having greater thicknesses and/or more pronounced curvature can be achieved.

In another embodiment, the present invention provides shaped egg products, produced by the methods described herein, that have reduced edging, increased thicknesses, improved consistency, substantially uniform dimensions and/or increased non-egg content.

A further embodiment of the present invention provides a method for manufacturing an egg pan by providing an aluminum base, and machine milling a plurality of recesses into the base that are configured to receive liquid egg material.

### BRIEF DESCRIPTION OF THE DRAWINGS

FIG. 1 is a top view of a portion of a conventional egg pan having circular recesses.

FIG. 2 is a bottom view of the egg pan of FIG. 1.

FIG. 3 is a top view of a portion of an egg pan according to an embodiment of the present invention.

FIG. 4 is a bottom view of a portion of an egg pan according to an embodiment of the present invention.

FIGS. 5A-5B are schematic illustrations of a commercial scale egg pan according to an embodiment of the present invention.

### DETAILED DESCRIPTION

Embodiments of the present invention provide methods for forming cooked egg products for use in ready-to-eat breakfast foods. The cooked egg products are formed as a unitary mass of cooked egg as distinguished from scrambled eggs, which include a plurality of discrete egg curds. In one embodiment, the egg products are formed by preparing a liquid egg mixture, depositing the mixture in machine milled recesses corresponding in shape to the desired egg product and then cooking the egg product.

The liquid egg mixture is formed by combining a liquid egg material with food chunks or particles. In one embodiment, the liquid egg material includes whole eggs, egg whites and/or egg yolks, along with one or more optional additives that are combined to form the liquid egg material. Optional additives include water, dairy substances (e.g., powdered milk), oil (e.g., soybean oil), various starches (e.g., corn/maize or tapioca starch), gums (e.g. xanthan gum), flavorants, salt and/or citric acid. For example, the egg based material may include between about 60 wt % and 90 wt % whole egg, up to about 15 wt % water, up to about 2 wt % powdered whole milk, up to about 3 wt % soybean oil, up to about 2 wt % starch, up to about 1 wt % salt, up to about 0.5 wt % xanthan gum and up to about 0.5 wt % citric acid.

A wide variety of suitable non-egg food materials may be combined with the liquid egg material prior to cooking, including various types of cheese, meats (e.g., bacon, ham or sausage), and vegetables (e.g., peppers, onions or potatoes). In one embodiment, the resulting mixture includes about 60 wt % liquid egg, 20 wt % cheese and 20 wt % ham, sausage or another meat product. Notably, this embodiment includes greater than 30 wt % food particles, more particularly between about 30-40 wt % food particular, as compared to conventional egg patties which tend to suffer from processing difficulties if more than about 30% food particles are used.

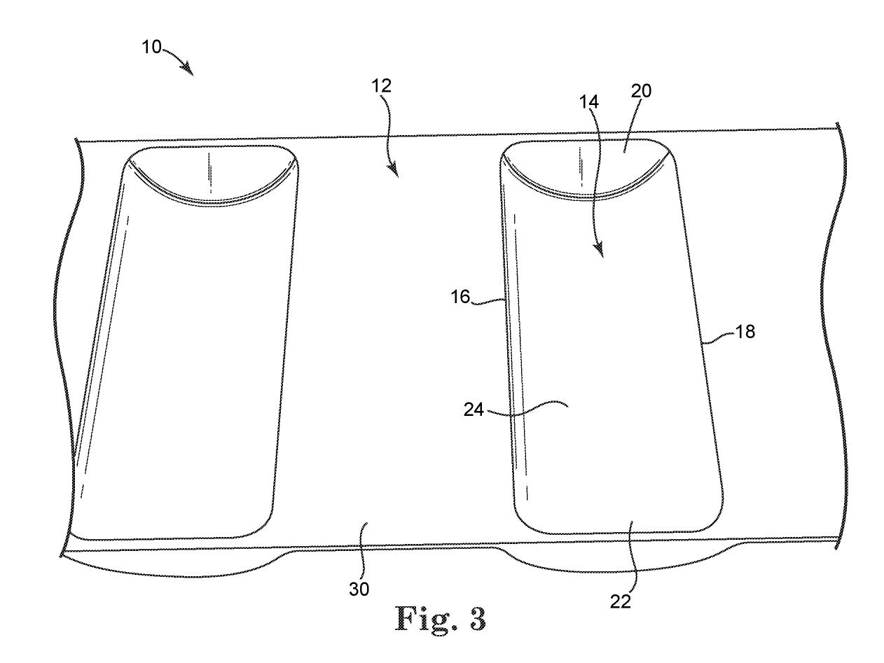

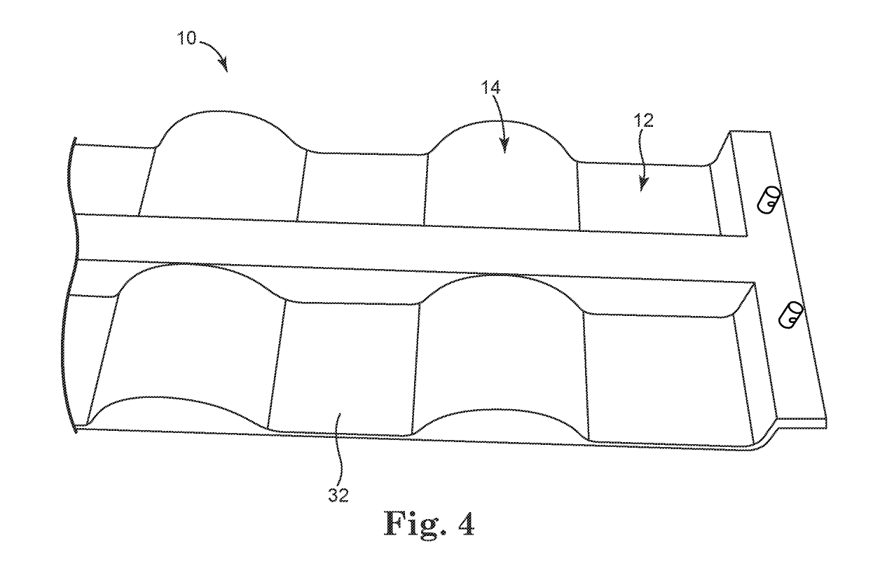

After combining and mixing the liquid egg material and food particles, the resulting liquid egg mixture is dispensed into oblong recesses formed in an egg pan and then cooked. FIGS. 3-4 show an egg pan 10 according to an embodiment of the present invention, which includes a base 12 having a plurality of recesses 14. The recesses 14 have a generally elongate, oblong shape having sides 16, 18, ends 20, 22 and bottom 24.

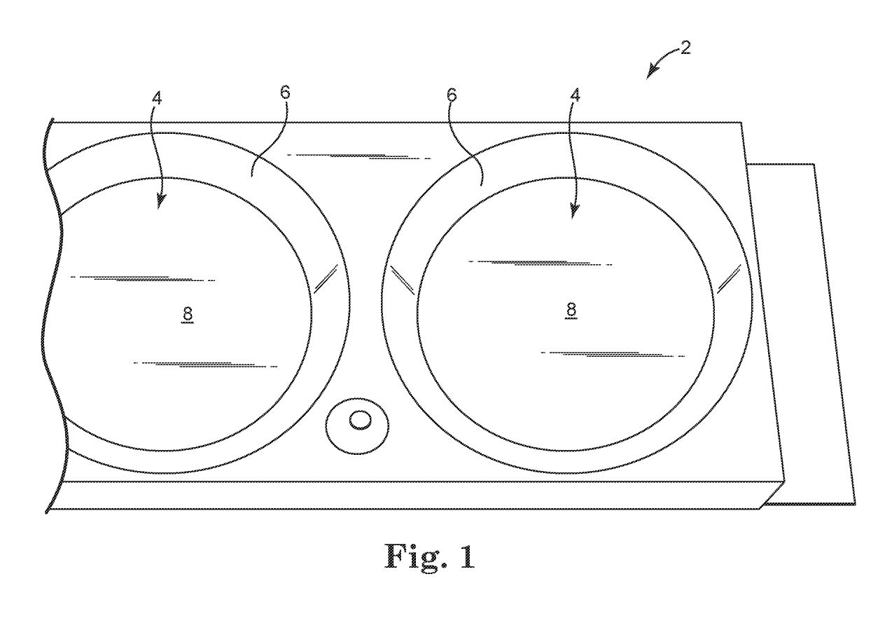

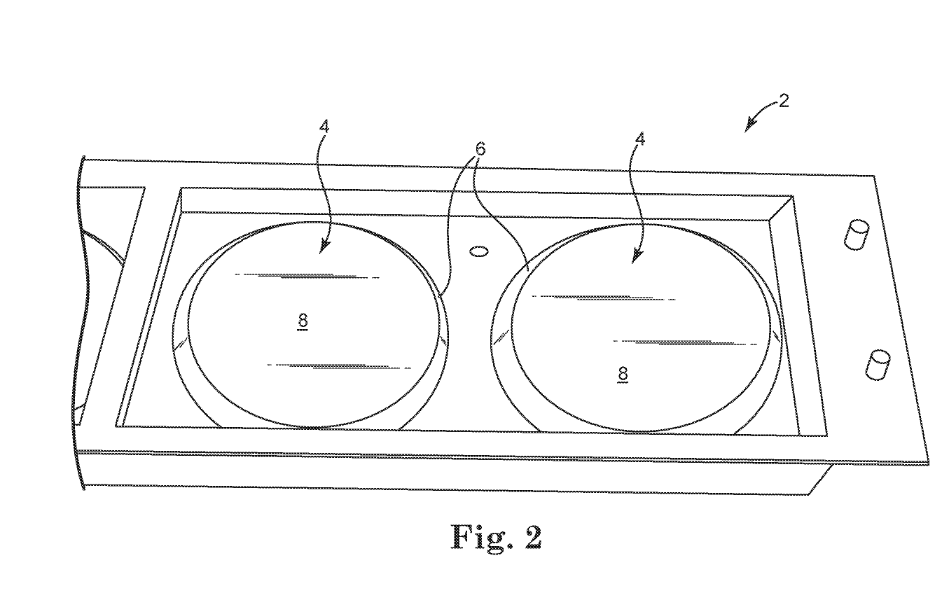

To provide the desired oblong shape for the egg loaf, the recesses 14 shown in FIG. 3 have a greater depth than the conventional pans shown in FIGS. 1 and 2. In one embodiment, the recesses 14 have a depth of greater than about 0.5 in., more particularly between about 0.625 in. and about 2 in. deep, and even more particularly between about 0.75 in. and about 1.5 in. deep. In another embodiment, the recesses 14 have a width of between about 1 in. and about 5 in., more particularly, between about 1.5 in. and about 3 in., and even more particularly between about 2 in. and 3 in. In a further embodiment, the recesses have a length between about 3 in. and about 6 in., and even more particularly between about 4 in. and about 5 in. As further shown in FIG. 3, sides 16, 18 and particularly ends 20, 22 are also substantially vertically oriented despite the significant depth of the recesses.

The pans shown in FIGS. 3-4 are formed by machine milling the recesses 14 into an aluminum or other suitable base 12 using a commercially available milling machine. A milling machine is a power-driven machine used for the complex shaping of metal parts. It includes a rotating cutter or endmill that rotates about a spindle axis (similar to a drill), and a movable table to which a workpiece is affixed. Milling machines may be operated manually or under computer control, and provide extremely accurate and consistent cuts across multiple workpieces. Unlike stamping, machine milling can be used to form complex recesses without forming cracks and/or fissures in the recess.

As part of the milling process according to embodiments of the present invention, an aluminum block is cut or otherwise formed into a desired dimension for the egg pan base 12. The recesses 14 are then machine milled into top side 30 of the base 12. Bottom side 32 of the base 12 is also machine milled to reduce the overall thickness and weight of the egg pan 10. After forming the recesses 14, a non-stick coating such as Teflon® can be applied as part of a separate coating process. The milling operation can be performed by a skilled machinist using commercially available milling machines.

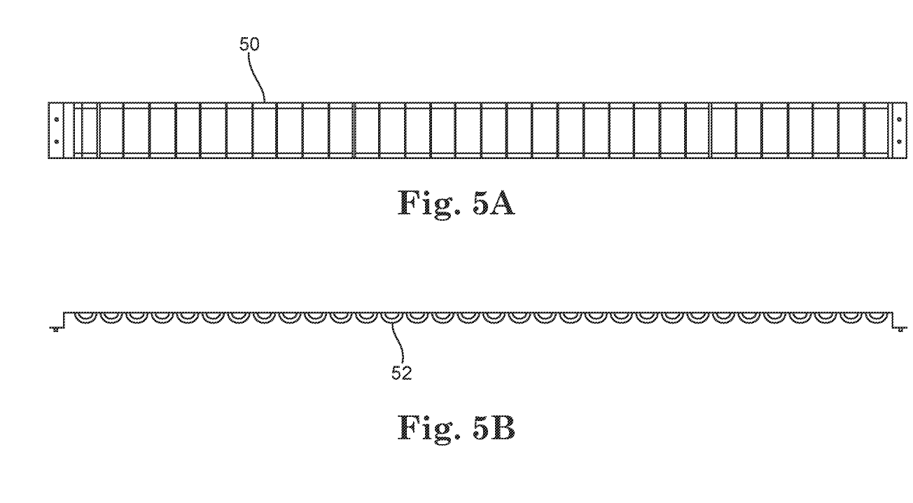

FIGS. 5A-5B show schematic illustrations of a top view and a side cross-sectional view of an egg pan 50 according to an embodiment of the present invention, which may be suitable for commercial scale egg cooking operations. The pan 50 in this embodiment includes a plurality of recesses 52 having dimensions similar to those described above. To accommodate the recesses 52, the illustrated pan 50 may have an overall length of between about 70 and 80 in., a width of between about 5 and 10 in. and a recess depth of between about 0.5 and about 2 in. In one embodiment, the pan has a length of about 76 in., a width of about 5.5 in. and a recess depth of about 1.25 in.

Machine milling the recesses in an aluminum base provides several benefits. First, unlike stainless steel stamping, the milling process produces consistent, accurate and repeatable recess dimensions. This may result in consistent egg products that can increase cooking efficiency and overall filling quality on a commercial scale and quantity.

Another benefit to cooking eggs in machine milled recesses is that the resulting egg filling has smooth edges that are less likely to pierce, tear or compromise the tortilla or other food product that encloses the filling. This also allows for the preparation of egg fillings having a significantly higher amount of non-egg material than traditional egg fillings, because the non-egg material tends to contribute to sharper edges on the filling.

In operation, the egg pans described above can be incorporated into a continuous commercial scale cooking operation. In one embodiment, one or more pans are placed on a horizontal conveyor. The pans are advanced to a filling machine that dispenses a predetermined volume (e.g., 2-4 oz) of liquid egg material into each recess. The pans are then advanced into an impingement oven that applies hot air to the liquid egg material at an operating temperature of between about 160° C. and 175° C., until the center of the egg material is cooked. In one embodiment, cooking time is between about 5 to 10 minutes, more particularly, between about 6 to 8 minutes. Cooking time will vary based on cooking temperature and vice versa. Once cooked, the shaped egg fillings are removed from the pan and are optionally frozen prior to preparing a completed food product, such as a breakfast wrap or burrito.

Various alternative embodiments of the present invention may be utilized. For example, the aluminum pans described above can be formed from any other metal, alloy or other material amenable to machining. Suitable metals include stainless steel, copper, brass, titanium, platinum, various alloys and other non-corrosive metals. Similarly, recesses having a variety of shapes, dimensions and depths can be formed if desired.

1. A method for preparing cooked shaped egg products comprising:
providing a liquid egg mixture;
providing an egg pan including a base and a plurality of recesses, wherein the plurality of recesses are machine milled into a first side of the base;
depositing the liquid egg material into the plurality of recesses; and
cooking the deposited liquid egg material to form a plurality of egg products having a shape corresponding to the shape of the recesses.

2. The method of claim 1 wherein the egg pan base comprises aluminum.

3. The method of claim 1 wherein the plurality of recesses comprise an oblong shape having first and second sides, first and second ends, and a bottom.

4. The method of claim 1 wherein the first and second ends of the recesses reside at about a 90° angle relative to the first side of the base.

5. The method of claim 1 wherein the recesses have a depth of greater than about 0.5 in.

6. The method of claim 5 wherein the recesses have a width of between about 1 in. and about 5 in.

7. The method of claim 5 wherein the recesses have a length of between about 3 in. and about 6 in.

8. The method of claim 1 wherein the recesses have a depth of between about 0.625 in. and about 2 in.

9. The method of claim 1 further comprising at least partially enclosing the shaped egg product in a non-egg food product.

10. The method of claim 9 wherein the non-egg food product comprises a tortilla, wrap, bagel, muffin, biscuit, or croissant.

11. A shaped egg product formed by the method of claim 1.

12. The shaped egg product of claim 11 comprising at least about 30% by weight non-egg material.

13. The shaped egg product of claim 11 having a thickness of greater than about ½ in., a width of between about 1 in. and about 5 in. and a length of between about 3 in. and about 6 in.

14. The shaped egg product of claim 11 wherein the thickness is between about 0.625 in. and about 2 in.

15. A method of forming a pan for cooking eggs:
providing a metal base having a thickness;
machine milling into the metal base a plurality of recesses sized and shaped to receive a liquid egg material, the recesses having a depth that is less than the thickness of the base.
